(19) United States
(12) Patent Application Publication
(10) Pub. No.: US 2009/0077801 A1
(43) Pub. Date: Mar. 26, 2009

(54) METHOD FOR THE SURFACE TREATMENT OF CR STEELS

(76) Inventors: Richard Brendon Scarlin, Oberflachs (CH); Stefan STRAUB, Mannheim (DE); Reinhard KNODLER, Dandhausen (DE)

Correspondence Address: CERMAK KENEALY VAIDYA & NAKAJIMA LLP, 515 E. BRADDOCK RD, ALEXANDRIA, VA, 22314, US

(21) Appl. No.: 12/136,829

(22) Filed: Jun. 11, 2008

(30) Foreign Application Priority Data
Jun. 15, 2007 (DE) 10 2007 028 321.2

(51) Int. Cl. B23P 15/04; B24C 1/10; B23P 15/00; B23P 15/02

(52) U.S. Cl. 29/889.7; 72/53

(57) ABSTRACT

A method for the surface treatment of ferritic/martensitic 9-12% Cr steels and of austenitic Cr steels for the purpose of achieving increased resistance to oxidation and solid particle erosion at application temperatures of above 500° C., in particular of approximately 650° C., in steam, includes that the surface of the steel is shot-peened with particles of aluminum or of an aluminum alloy; optionally, in a subsequent step, the surface of the steel is smoothed to a roughness of <0.5 μm, preferably <0.3 μm. Following additional heat treatment is not necessary, and the parts thus treated may be employed, for example, as blades in steam turbines.

This application claims priority under 35 U.S.C. § 119 to German application no. 10 2007 028 321.2, filed 15 Jun. 2007, the entirety of which is incorporated by reference herein.

### BACKGROUND

1. Field of Endeavor

The invention relates to the field of material technology. It relates to a method for the surface treatment of ferritic/martensitic 9-12% Cr steels and of high-alloy austenitic Cr steels which are predominantly for the production of components employed in steam power stations. These steels are exposed to high temperatures (typically 600 to 650° C.) and therefore have to be protected against damage, that is to say loss of quality, as a result of oxidation and subsequent flaking.

2. Brief Description of the Related Art

It is known that austenitic steels which are highly alloyed, inter alia, with chromium are employed for superheater and intermediate superheater tubes in power stations. Of austenitic steels, it is known that an improved oxidation behavior of the material can be achieved by a cold forming of the surface, for example by bombarding the surface of the steel with small particles of a carbon steel at high velocity (=shot peening). The reason for this is a martensitic transformation of the surface thus treated, during which a large number of grain boundaries arise which, in turn, enable the chromium present in the steel to migrate onto the surface and there form chromium oxides which then protect the material against further oxidation (see D. Caplan, Corr. Science 6 (1966), 509 and Y. Minami, NKK Tech. Rev. 75 (1996), 1).

Furthermore, ferritic/martensitic steels with approximately 9-12% Cr, which are predominantly for tubes, valves, and housings, are known. Mention may be made, as examples of these steels, P92 (chemical composition in % by weight: 0.12 C, 0.5 Mn, 8.9 Cr, 0.4 Mo, 1.85 W, 0.2 V and the rest iron and unavoidable impurities) and also E911 (chemical composition in % by weight: 0.11 C, 0.35 Mn, 0.2 Si, 9.1 Cr, 1.01 Mo, 1.00 W, 0.23 V and the rest iron and unavoidable impurities). These ferritic/martensitic steels, because of their chemical composition, are generally less oxidation-resistant than austenitic steels, but they usually likewise have to withstand high temperatures of up to 620° C. in modern power stations. To protect steels of this type against harmful oxidation, therefore, special coatings were developed (A. Agüero, R. Muelas, Mat. Sci. Forum, Vol. 461 (1994), 957). These coatings have the disadvantage, on the one hand, of being costly and, on the other hand, of not always being reliable. If coatings are applied, there is still the need for a heat treatment or even several heat treatments which, in turn, are costly and time-consuming, particularly because, in power station construction, very large components have to be heat-treated. Alternative, above all simpler, possibilities for protection against oxidation for ferritic/martensitic steels of this type have therefore already been in demand for a relatively long time.

In contrast to austenitic steels, however, in ferritic/martensitic steels the known shot peening does not have the above-described positive effect on account of the different structure.

However, H. Haruyama, H. Kutsumi, S. Kuroda, F Abe, Proc. of EPRI Conf., (2004), 659-667, reported a slight increase in the oxidation resistance of such steels in steam when these have been shot-peened with pure chromium particles before temperature and steam loading and have subsequently been subjected to heat treatment at 700° C. The latter, however, has the disadvantage of being highly cost-intensive and is not desirable in terms of the desired structure in power station construction.

### SUMMARY

One of numerous aspects of the present invention involves a method for the surface treatment of ferritic/martensitic 9-12% Cr steels and austenitic steels highly alloyed by Cr, by which it is possible to vary the structure of said steels on the surface such that, as compared with the steels which are untreated in each case, a greatly improved oxidation behavior and increased resistance to solid particle erosion at application temperatures above 500° C., in particular of around 650° C., in steam are achieved. The method is to be capable of being used cost-effectively and simply and is to lead to good results without any additional heat treatment of the components.

Another aspect includes that, in a method for the surface treatment of said steels, the surface of the steel is shot-peened with particles formed of aluminum or aluminum alloy for the purpose of increasing resistance to oxidation and solid particle erosion.

One advantage of methods embodying principles of the present invention is that ferritic/martensitic 9-12% Cr steels, and also austenitic steels highly alloyed with chromium, which are surface-treated in this way, are distinguished by improved oxidation resistance with respect to the reference steels which are untreated in each case, when they are employed at high temperatures in a steam environment, such as is typical, for example, in the case of blades of a high-temperature steam turbine. They have a substantially lower weight increase, along with the same precipitation times.

Exemplary methods moreover, are cost-effective, since they manage without the additional heat treatment steps necessary in the prior art for known methods.

Exemplary methods have the surprising effect that a process other than the strain hardening process, ineffective in ferritic/martensitic steels, clearly plays a part on the surface of the material. One possibility is that the Al particles are embedded into the surface or else a microalloying of the surface takes place, thus giving rise to a protective action against oxidation.

In austenitic Cr steels treated by methods according to the invention, in addition to the last-mentioned effect, there is also a certain known action of the strain hardening process as a result of the transformation of the austenitic structure on the surface into a martensitic structure, although this effect may only be slight on account of the low hardness of the Al particles.

It is particularly advantageous if the steel shot-peened with Al or aluminum alloy particles is subsequently finely smoothed on the surface in a further method step, in which case a surface roughness of <0.5 μm, in particular <0.3 μm, should be set. What is achieved thereby is that the high resistance to oxidation and solid erosion can be maintained throughout the operating temperature of above 500° C. for a steam turbine blade formed of said steels.

### BRIEF DESCRIPTION OF THE DRAWINGS

An exemplary embodiment of the invention is illustrated in the drawing in which:

FIG. 1 shows the oxidation behavior of a ferritic 11.5% Cr steel treated according to the invention (shot-peened with particles formed of an Al alloy), at 650° C./steam, as compared with the oxidation behavior of a ferritic 11.5% Cr steel treated according to the prior art (shot-peened steel particles), and

FIG. 2 shows the oxidation behavior of an austenitic 18.8 CrNi steel treated according to the invention, at 650° C./steam, as a function of the type of material of the shot-peening particles.

### DETAILED DESCRIPTION OF EXEMPLARY EMBODIMENTS

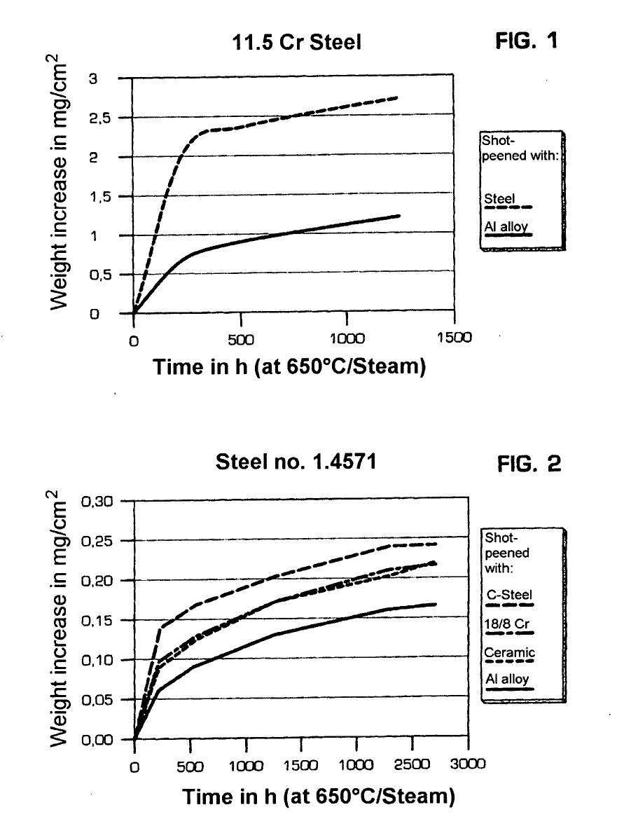

The invention is explained in more detail below with reference to an exemplary embodiment and to FIG. 1 to 2.

A ferritic Cr steel with the following chemical composition (values in % by weight):

0.2 C

0.5 Mn

0.28 Si

11.6 Cr

0.8 Mo

0.7 Ni

0.27 V

The rest iron and unavoidable impurities was treated according to an exemplary embodiment of the invention. In this case, in this exemplary embodiment, the abovementioned steel was shot-peened with particles formed of an aluminum alloy (grain size: 200-400 μm). The Al alloy had a hardness of 90 to 120 HV 0.2 and had the following chemical composition:
5.5 to 7% Cu
<1% Fe
>1.6% Si
≦1.5% Zn
≦0.15 Ti
≦0.2 Ni
≦0.3 Mn
≦0.15 Pb
≦0.1 Sn.

The surface of the steel was shot-peened for five minutes with these particles, the pressure amounting to approximately 6 bar and the nozzle having an angle of 80-85° to the surface.

It is advantageous that a subsequent heat treatment of the material is not necessary. Methods according to the invention can therefore be used cost-effectively and simply.

FIG. 1 illustrates the oxidation behavior of a ferritic 11.5% Cr steel treated according to an exemplary embodiment of the invention, that is to say shot-peened with particles formed of an Al alloy, at 650° C./steam, as compared with the oxidation behavior of a ferritic 11.5% Cr steel shot-peened with steel particles.

The steel treated according to the method described herein is distinguished by a substantially improved oxidation behavior. It can be seen clearly in FIG. 1 that, throughout the measurement time, the weight increase in the material treated according to the invention is substantially lower than in the reference steel which was shot-peened with steel particles. After a precipitation time of approximately 500 hours, for example, the weight increase is more than twice as high in the reference steel than in the steel of identical composition treated according to the method herein described.

The method has the surprising effect that a mechanism other than the strain hardening process, ineffective in ferritic/martensitic steels, caused by shot peening with steel balls on the surface of the material plainly plays a role. One possibility is that the particles formed of the Al alloy are embedded into the surface of the steel or else a microalloying of the steels takes place on the surface, thus giving rise to a protective action against oxidation.

Another positive effect of this method is associated with the efficiency of steam turbines. In order to ensure a high aerodynamic efficiency of the steam turbine, the blades are manufactured from the outset with a very fine surface (final roughness 0.3 μm). This low roughness level has to be maintained throughout the long operating time of the blades. However, during operation, the surface of the material may be roughened due to the impingement and impact of hard (oxide) particles which have come loose from the component surface upstream of the blade or else the oxidation of the blade surface in the high-temperature steam environment itself causes oxides to flake off from the surface, consequently giving rise to an extreme roughening of the surface. The herein-described method should therefore advantageously be supplemented by a subsequent step for smoothing the surface, in particular by tumbling.

It became apparent that, advantageously, by smoothing, following the surface treatment method, of the surface to a roughness of below 0.5 μm, preferably below 0.3 μm, the oxidation behavior of the steel can be further improved and also the resistance to solid particle erosion can be increased.

FIG. 2 illustrates the oxidation behavior of an austenitic Cr—Ni steel treated according to the invention, at 650° C./steam, as a function of the type of material of the shot-peening particles used. This is the steel 1.4571 have the following chemical composition (values in % by weight):
max 0.08 C
max. 1.00 Si
max. 2.00 Mn
max. 0.0045 P
max. 0.030 S
16.5-18.5 Cr
2.0-2.5 Mo
10.5-13.5 Ni
5×C Ti (hence, max. 0.4 Ti)
the rest Fe.

Samples of this steel were shot-peened with particles from an austenitic 18.8 CrNi steel, an unalloyed carbon steel (cast steel) with a bainitic/martensitic structure, of an aluminum alloy, and of a ceramic material, and were subsequently precipitated for a period of time of approximately 2700 h in steam having a temperature of 650° C. The pressure in each case amounted to approximately 6 bar for steel particles and the Al alloy particles and to approximately 3 bar for the ceramic particles. In each case an angle of the nozzle to the surface of 80-85° was set.

The chemical composition (values in % by weight) of the shot-peening particles was as follows:

1. Unalloyed carbon steel:
0.14-0.18 C, 0.65-0.85 Si, 0.35-0.55 Mn, <0.015 S, <0.015 P, the rest Fe

2. 18.8 CrNi steel:
0.22 C, <2.6 Si, <1.80 Mn, ca. 18 Cr, ca. 10 Ni, the rest Fe

3. Aluminum alloy:
5.50-7.50 Cu, ≦1.50 Zn, ≦1.60 Si, ≦1.00 Fe, ≦0.15 Ti, ≦0.20 Ni, ≦0.30 Mn, ≦0.20 Mg, ≦0.15 Pb, ≦0.10 Sn, the rest Al

4. Ceramic beads:
67 ZrO₂, 31 SiO₂, 2 Al₂O₃

The steel which was shot-peened with the particles of the carbon steel in this case exhibited the most weight increase, that is to say the worst oxidation behavior, throughout the period of investigation, while the steel which was shot-peened with the particles of the Al alloy had the best properties, that is to say the lowest weight increase. The samples shot-peened with the particles of the ceramic material or of the 18.8 CrNi steel have approximately equal weight increases and lay exactly between the values described above.

Methods according to the invention can be used particularly for components, for example blades, formed of ferritic/martensitic 9-12 Cr steels or of austenitic CrNi steels, which are exposed to temperatures of above 550° C. in gas and steam turbines.

Of course, the invention is not restricted to the exemplary embodiment described. Both the material and the treatment parameters may be varied.

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. A method for the surface treatment of ferritic/martensitic 9-12% Cr steels and of high-alloy austenitic Cr steels, for achieving an improved oxidation behavior and increased resistance to solid particle erosion at application temperatures of above 500° C., in steam, the method comprising:
shot-peening the surface of the steel with particles formed of a material selected from the group consisting of aluminum and an aluminum alloy.

2. The method as claimed in claim 1, further comprising:
smoothing the surface of the steel to a roughness of below 0.5 μm after said shot-peening.

3. The method as claimed in claim 3, wherein smoothing comprises smoothing to a roughness of below 0.3 μm.

4. The method as claimed in claim 1, wherein the steel comprises a portion of a turbine component.

5. The method as claimed in claim 1, wherein the steel comprises a portion of a turbine blade.
